(19) United States
(12) Patent Application Publication
(10) Pub. No.: US 2015/0126062 A1
(43) Pub. Date: May 7, 2015

(54) CONNECTION STRUCTURE OF OUTER CONDUCTOR TERMINAL TO ELECTRIC WIRE

(71) Applicant: Yazaki Corporation, Minato-ku, Tokyo (JP)

(72) Inventors: Hajime Kato, Kakegawa-shi (JP); Kazuhiro Tomine, Kakegawa-shi (JP); Takaaki Miyajima, Kakegawa-shi (JP)

(73) Assignee: Yazaki Corporation, Minato-ku, Tokyo (JP)

(21) Appl. No.: 14/397,594

(22) PCT Filed: May 2, 2013
(86) PCT No.: PCT/JP2013/063227

§ 371 Date: Oct. 28, 2014

(30) Foreign Application Priority Data
May 2, 2012 (JP) 2012-105123

(51) Int. Cl. H01R 9/05; H01R 43/02; H01R 4/20

(52) U.S. Cl. CPC H01R 9/0518; H01R 4/20; H01R 43/0207
USPC 439/585

(57) ABSTRACT

An outer conductor terminal for connecting an electric wire to an outer conductor, the electric wire including an internal conductor, an insulating cover covering an outer periphery of the internal conductor, an outer conductor having a twisted wire to wrap an outer periphery of the insulating cover, and a protective cover covering an outer periphery of the outer conductor includes a terminal part that is formed at one end portion of a flat plate, a cylindrical part that is formed at the other end portion of the flat plate by bending the other end of the flat plate and covers a part of the outer periphery of the insulating cover adjacent to an exposed portion of the outer conductor exposed by stripping the protective cover or a part of an outer periphery of the protective cover adjacent to the exposed portion.

### TECHNICAL FIELD

The invention relates to a connection structure of an outer conductor terminal to an electric wire, and more particularly, to a connection structure of an outer conductor terminal that is connected to an outer conductor wound to wrap an outer periphery of a single wire or a plurality of wires.

### BACKGROUND ART

For example, a coaxial electric wire having an outer conductor wound on an outer periphery of a single wire includes an inner conductor, an insulating cover of the inner conductor, an outer conductor having a twisted wire wound on an outer periphery of the insulating cover and a protective cover (or insulating cover) of the outer conductor. When the outer conductor of the coaxial electric wire is used as a shield conductor and the like, in general, an outer conductor terminal is connected to the outer conductor that is exposed by stripping the protective cover of an electric wire end and the outer conductor terminal is then connected to an external circuit such as ground potential and the like.

As an example of the connection structure of the outer conductor terminal to the coaxial electric wire, PTL1 discloses a terminal processing structure of a shield electric wire. According to the disclosure, an outer conductor terminal having a terminal part and a cylindrical part, which are formed by bending a plate material, is put on an electric wire from an outer conductor-side that is exposed by stripping a protective cover, the exposed part of the outer conductor is folded over an outer periphery of the cylindrical part of the outer conductor terminal and a fastening ring is crimped onto the outer periphery of the cylindrical part of the outer conductor terminal from the folded outer conductor, so that the outer conductor terminal is connected to the outer conductor.

### CITATION LIST

### Patent Literature

PTL 1: JP-A-2002-218622

### SUMMARY OF INVENTION

### Technical Problem

However, according to the connection structure of the outer conductor terminal disclosed in PTL1, an axial length of the cylindrical part is lengthened as a length of the fastening ring. Hence, a problem occurs in that a size (shape) of the connection part of the outer conductor terminal is increased.

An object of the invention is to provide a connection structure of an outer conductor terminal to an electric wire, which can reduce a size of a connection part of the outer conductor terminal.

### Solution to Problem

According to an aspect of the invention, an outer conductor terminal for connecting an electric wire to an outer conductor, the electric wire including an internal conductor, an insulating cover covering an outer periphery of the internal conductor, an outer conductor having a twisted wire to wrap an outer periphery of the insulating cover, and a protective cover covering an outer periphery of the outer conductor, includes a terminal part that is formed at one end portion of a flat plate, a cylindrical part that is formed at the other end portion of the flat plate by bending the other end of the flat plate and covers a part of the outer periphery of the insulating cover adjacent to an exposed portion of the outer conductor exposed by stripping the protective cover or a part of an outer periphery of the protective cover adjacent to the exposed portion, and a C-shaped ring that has an opening portion at a position corresponding to the terminal part and covers the cylindrical part. The twisted wire of the outer conductor is in contact with an outer periphery of the cylindrical part and an inner periphery of the C-shaped ring. The C-shaped ring is crimped to connect the twisted wire of the outer conductor to the outer periphery of the cylindrical part.

According to the invention, the twisted wire of the outer conductor is arranged to contact an outer periphery of the cylindrical part of the outer conductor terminal put on an end portion of the electric wire, the C-shaped ring is put on the outer periphery of the twisted wire and the C-shaped ring is crimped to connect the twisted wire of the outer conductor to the outer periphery of the cylindrical part. Therefore, since it is possible to shorten an axial length of the cylindrical part, it is possible to reduce a size of a connection part of the outer conductor terminal. That is, the axial length of the connection part of the outer conductor terminal is merely a sum of an exposed length of the inner conductor, an exposed length of the insulating cover and a length of the cylindrical part of the outer conductor terminal overlapping with the exposed length of the twisted wire. Compared to this, an axial length of the connection part of the outer conductor terminal disclosed in PTL1 is a length that is obtained by further adding an axial length of the fastening ring.

In this case, the C-shaped ring has the lip portion that is formed by bending the leading edge of the opening toward an outer side of the ring. Also, in this case, the lip portion may be ultrasonically welded to the terminal part of the outer conductor terminal.

### Advantageous Effects of Invention

According to the invention, it is possible to reduce the size of the connection part of the outer conductor terminal

### BRIEF DESCRIPTION OF DRAWINGS

FIGS. 1A to 1F show a manufacturing sequence of a first illustrative embodiment relating to a connection structure of an outer conductor terminal to an electric wire of the invention.

FIGS. 2A and 2B show sectional views of a connection part of the outer conductor terminal shown in FIGS. 1E and 1F.

FIG. 3 is a perspective view showing an outward appearance of a modified embodiment of the first illustrative embodiment relating to the connection structure of the outer conductor terminal to the electric wire of the invention.

FIG. 4 is a perspective view showing an outward appearance of another modified embodiment of the first illustrative embodiment relating to the connection structure of the outer conductor terminal to the electric wire of the invention.

FIGS. 5A to 5G show a manufacturing sequence of a second illustrative embodiment relating to a connection structure of an outer conductor terminal to an electric wire of the invention.

FIGS. 6A and 6B show sectional views of a connection part of the outer conductor terminal shown in FIGS. 5F and 5G.

FIG. 7 is a perspective view showing an outward appearance of a modified embodiment of the second illustrative embodiment relating to the connection structure of the outer conductor terminal to the electric wire of the invention.

FIG. 8 is a perspective view showing an outward appearance of another modified embodiment of the second illustrative embodiment relating to the connection structure of the outer conductor terminal to the electric wire of the invention.

### DESCRIPTION OF EMBODIMENTS

Hereinafter, a connection structure of an outer conductor terminal to an electric wire of the invention will be described based on illustrative embodiments.

### First Illustrative Embodiment

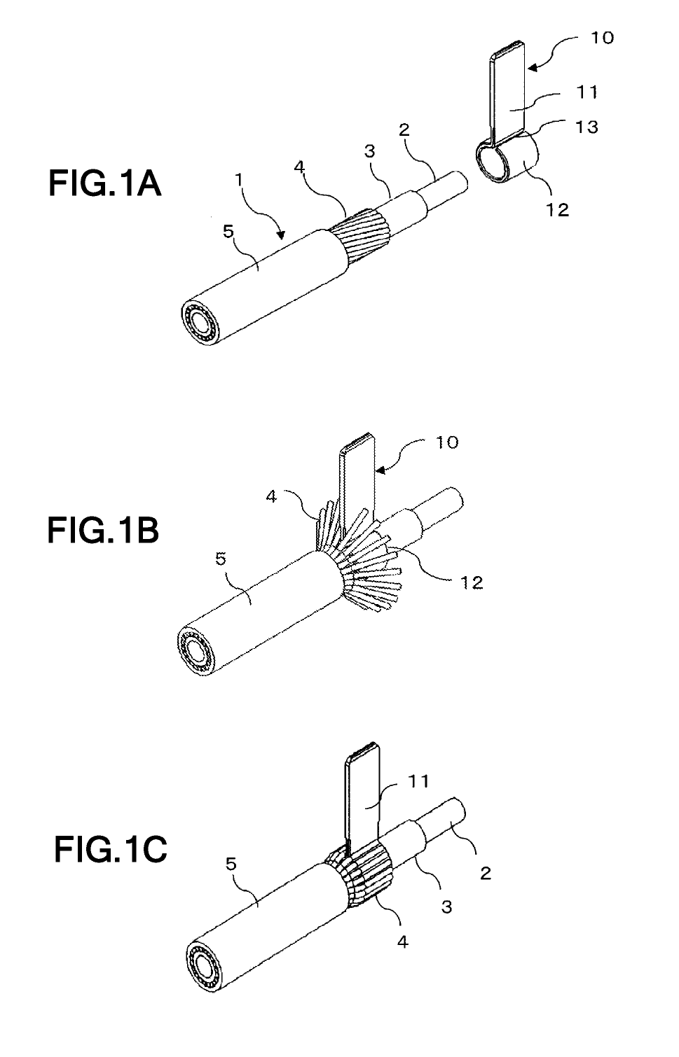

FIGS. 1A to 1F show a manufacturing sequence of a first illustrative embodiment relating to a connection structure of an outer conductor terminal to an electric wire of the invention. In this illustrative embodiment, the invention is applied to a connection structure of an outer conductor terminal to a coaxial electric wire. However, the invention is not limited thereto and may be also applied to a connection structure of an outer conductor terminal that is connected to an outer conductor provided to wrap an outer periphery of an insulating cover of a plurality of electric wires. As shown in FIG. 1A, an electric wire 1 includes a core wire 2 that is an inner conductor, an insulating cover 3 of the core wire 2, an outer conductor 4 that is formed by winding a plurality of twisted wires on an outer periphery of the insulating cover 3 and a protective cover 5 that is provided to cover an outer periphery of the outer conductor 4. In the meantime, the protective cover 5 may be formed to have required insulating performance. Also, the coaxial electric wire 1 may be used for a direct current circuit in which the core wire 2, which is the inner conductor, is set as a positive potential P and the outer conductor 4 is set as a negative potential N. However, the invention is not limited thereto and may be also used for a three-phase alternating current or single-phase three-line circuit having a plurality of core wires 2.

The connection structure of the outer conductor terminal of this illustrative embodiment is described in accordance with the manufacturing sequence with reference to FIGS. 1A to 1F. In order to connect the outer conductor 4 of the electric wire 1 to an external circuit, in general, an outer conductor terminal is electrically connected to the outer conductor 4 at an end portion of the electric wire 1, which is then withdrawn to the outside. As shown in FIG. 1A, the protective cover 5 is stripped at one end of the electric wire 1 over a predetermined length and the insulating cover 3 is also stripped so as to connect a signal terminal and the like to a leading end portion of the core wire 2. Also, a leading end position of the outer conductor 4 is determined while securing an insulating distance between the core wire 2 of the leading end portion and the outer conductor 4, and the protective cover 5 is stripped to thus expose a leading end portion of the outer conductor 4 so as to connect an outer conductor terminal 10. In this illustrative embodiment, the outer conductor terminal 10 is formed by using a band plate-shaped flat plate and includes a terminal part 11 that is formed at one end portion of the band plate and a cylindrical part 12 that is formed by bending the other end portion of the band plate. A bent end of the cylindrical part 12 is positioned at an appropriate interval from a base end portion of the terminal part 11. Also, an inner diameter of the cylindrical part 12 is formed to fit with an outer diameter of the insulating cover 3.

Then, as shown in FIG. 1B, the twisted wires of the outer conductor 4 are untwisted and are unfolded into an umbrella shape and the cylindrical part 12 of the outer conductor terminal 10 is put on the core wire 2 and the insulating cover 3 from the end portion-side of the electric wire 1 and is then inserted between the outer conductor 4 unfolded into the umbrella shape and the insulating cover 3. Then, as shown in FIG. 1C, the twisted wires of the outer conductor 4 are contacted to an outer periphery of the cylindrical part 12 of the outer conductor terminal 10. As can be understood from the drawing, a length of stripping the protective cover 5 to thus expose the leading end portion of the outer conductor 4 is preferably matched with an axial length of the cylindrical part 12 of the outer conductor terminal 10.

Then, as shown in FIG. 1D, a C-shaped ring 20 is put on the core wire 2 and the insulating cover 3 from the end portion-side of the electric wire 1. At this time, an opening 21 of the C-shaped ring 20 is positioned to match with an orientation of the terminal part 11 of the outer conductor terminal 10. Then, as shown in FIG. 1E, the C-shaped ring 20 is put on the outer periphery of the outer conductor 4 consisting of the twisted wires arranged to contact the outer periphery of the cylindrical part 12. Then, a caulking operation is performed from the outer periphery of the C-shaped ring 20 toward the cylindrical part 12 of the outer conductor terminal 10, so that the twisted wires of the outer conductor 4 are crimping-connected to the outer periphery of the cylindrical part 12, as shown in FIG. 1F. Also, as shown in FIG. 1F, after the outer conductor terminal 10 is connected, a signal terminal 30 may be ultrasonically welded onto the exposed part of the core wire 2, for example.

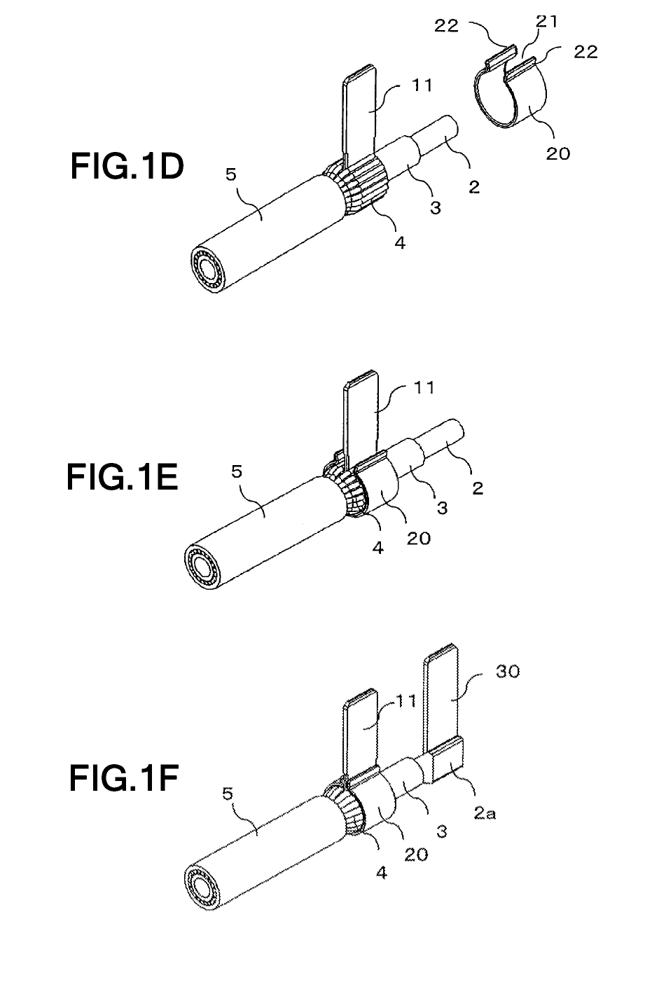

In the meantime, lip portions 22 may be formed by bending leading edges of both sides of the opening 21 of the C-shaped ring 20 toward an outer side of the ring. Thereby, the leading edges of the opening 21 of the C-shaped ring 20 are favorably contacted to the cylindrical part 12 of the outer conductor terminal 10. FIGS. 2A and 2B show sectional views of the connection part seen from a direction orthogonal to an axis of the cylindrical part 12 of the outer conductor terminal 10 shown in FIGS. 1E and 1F, respectively. As can be seen from FIGS. 2A and 2B, FIG. 2A shows a sectional state before the C-shaped ring 20 is crimped and FIG. 2B shows a sectional state after the C-shaped ring 20 is crimped.

As described above, according to the first illustrative embodiment, the twisted wires of the outer conductor 4 are arranged to contact the outer periphery of the cylindrical part 12 of the outer conductor terminal 10 put on the end portion of the electric wire 1, the C-shaped ring 20 is put on the outer periphery of the twisted wires and the C-shaped ring 20 is crimped to connect the twisted wires of the outer conductor 4 to the outer periphery of the cylindrical part 12. Therefore, it is possible to shorten the axial length of the cylindrical part 12. That is, the axial length of the connection part of the outer conductor terminal 10 is merely a sum of the exposed length of the core wire 2 that is the inner conductor, the exposed length of the insulating cover 3 and the length of the cylindrical part 12 of the outer conductor terminal 10 overlapping with the exposed length of the twisted wires. As a result, it is possible to reduce the size of the connection part of the outer conductor terminal disclosed in PTL1.

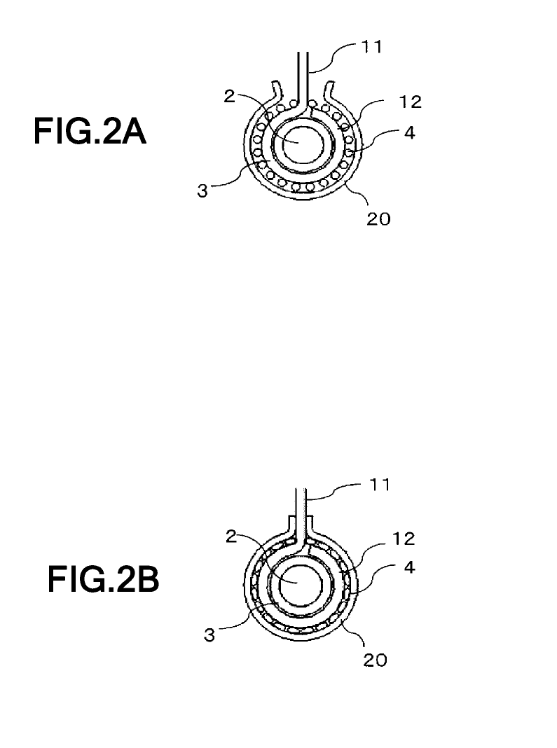

In the first illustrative embodiment, the C-shaped ring 20 is crimped to connect the outer conductor to the cylindrical part 12 of the outer conductor terminal 10. In addition to this, the lip portions 22 may be lengthened as lip portions 23 shown in FIG. 3 and the lip portions 23 may be ultrasonically welded to the terminal part 11.

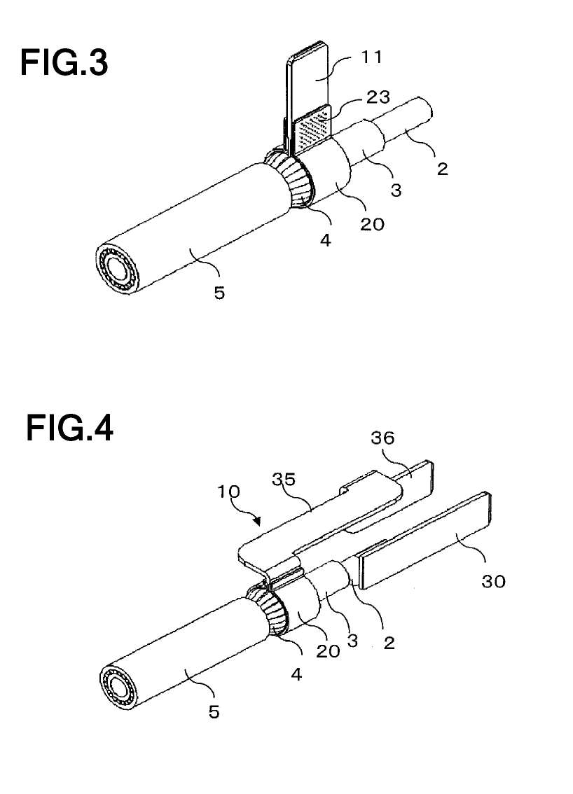

Also, in the first illustrative embodiment, the terminal part 11 of the outer conductor terminal 10 has the flat plate shape. However, the invention is not limited thereto and can be also applied to an outer conductor terminal having a shape where a terminal 35 and a terminal 36 having a flat plate shape, which are formed in conformity to a shape of a mating terminal of a connection target by bending a plate material, are connected, as shown in FIG. 4.

### Second Illustrative Embodiment

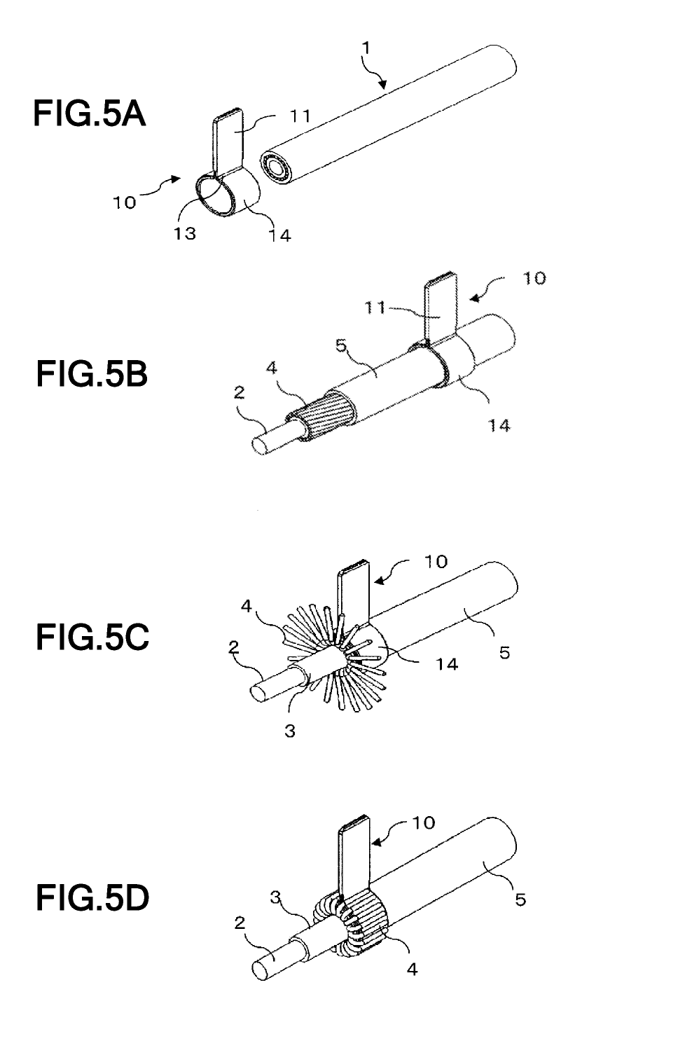

FIGS. 5A to 5G show a manufacturing sequence of a second illustrative embodiment relating to a connection structure of an outer conductor terminal to an electric wire of the invention. This illustrative embodiment is different from the first illustrative embodiment in that while the cylindrical part 12 of the outer conductor terminal 10 is inserted between the outer conductor 4 and the insulating cover 3 and the C-shaped ring 20 is crimped thereto in the first illustrative embodiment, a cylindrical part 14 of the outer conductor terminal 10 is put on the outer periphery of the protective cover 5, the exposed outer conductor 4 is folded onto the outer periphery of the protective cover 5 and contacted to the outer periphery of the cylindrical part 14 and then a C-shaped ring 25 is crimped thereto in the second illustrative embodiment. Therefore, an inner diameter of the cylindrical part 14 of the outer conductor terminal 10 is increased in conformity to the outer diameter of the protective cover 5 and an inner diameter of the C-shaped ring 25 is correspondingly increased. Since the other configurations are the same as those of the first illustrative embodiment, the same parts are denoted with the same reference numerals and the descriptions thereof are omitted.

The manufacturing sequence of the second illustrative embodiment is described with reference to FIGS. 5A to 5G As shown in FIG. 5A before processing a terminal part of the electric wire 1, the cylindrical part 14 having a large inner diameter of the outer conductor terminal 10 is put on the electric wire 1 from an end portion-side of the electric wire 1. Then, as shown in FIG. 5B, the insulating cover 3 is stripped to expose the core wire 2 by a necessary length and the protective cover 5 is also stripped to expose the outer conductor 4 by a necessary length. Then, as shown in FIG. 5C, the cylindrical part 14 of the outer conductor terminal 10 is positioned at an end portion of the protective cover 5 and the twisted wires of the outer conductor 4 are unfolded. Then, as shown in FIG. 5D, the unfolded twisted wires are folded onto the cylindrical part 14 of the outer conductor terminal 10 and contacted to the outer periphery of the cylindrical part 14. Then, as shown in FIG. 5E, the C-shaped ring 25 having a large inner diameter is put on the outer periphery of the outer conductor 4, which has been folded onto the outer periphery of the cylindrical part 14, from the end portion-side of the electric wire 1. At this time, as shown in FIG. 5F, the opening 21 of the C-shaped ring 25 is positioned to match with an orientation of the terminal part 11 of the outer conductor terminal 10 and the C-shaped ring 25 is mounted so that the twisted wires of the outer conductor 4 are inserted between the C-shaped ring 25 and the outer periphery of the cylindrical part 14. Then, a caulking operation is performed from the outer periphery of the C-shaped ring 25 toward the cylindrical part 14 of the outer conductor terminal 10, so that the twisted wires of the outer conductor 4 are crimping-connected to the outer periphery of the cylindrical part 14, as shown in FIG. 5G. Also, after the outer conductor terminal 10 is connected, the signal terminal 30 may be ultrasonically welded onto an exposed part 2a of the core wire 2, for example.

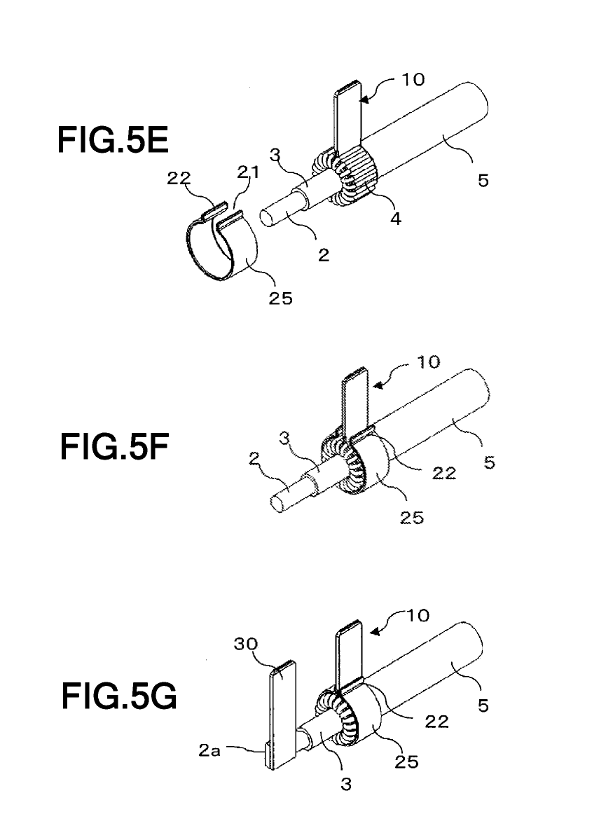

In the meantime, like the first illustrative embodiment, the lip portions 22 may be formed by bending the leading edges of both sides of the opening 21 of the C-shaped ring 25 toward an outer side of the ring. Thereby, the leading edges of the opening 21 of the C-shaped ring 25 are favorably contacted to the cylindrical part 14 of the outer conductor terminal 10. FIGS. 6A and 6B show sectional views of the connection part seen from a direction orthogonal to an axis of the cylindrical part 14 of the outer conductor terminal 10 of FIGS. 5F and 5G, respectively. As can be seen from FIGS. 6A and 6B, FIG. 6A shows a sectional state before the C-shaped ring 25 is crimped and FIG. 6B shows a sectional state after the C-shaped ring 25 is crimped.

As described above, according to the second illustrative embodiment, it is possible to shorten the axial length of the cylindrical part 14, like the first illustrative embodiment. That is, the axial length of the connection part of the outer conductor terminal 10 is merely a sum of the exposed length of the core wire 2 that is the inner conductor, the exposed length of the insulating cover 3 and the length of the cylindrical part 14 of the outer conductor terminal 10 overlapping with the exposed length of the twisted wires. As a result, it is possible to reduce the size of the connection part of the outer conductor terminal disclosed in PTL1.

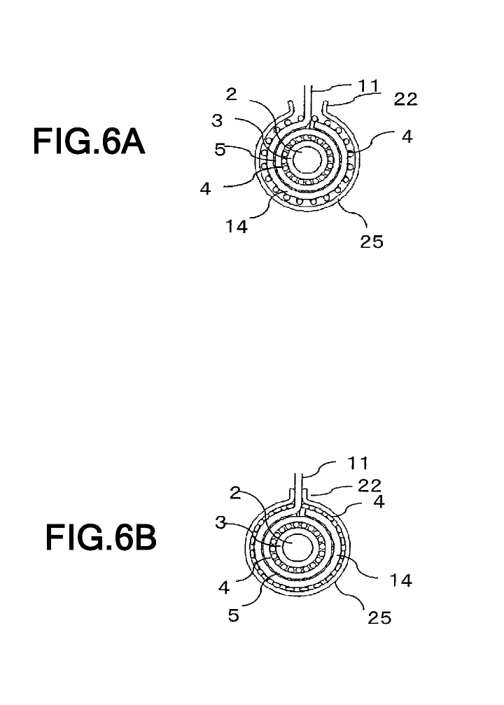

In the second illustrative embodiment, the C-shaped ring 25 is crimped to connect the outer conductor to the cylindrical part 14 of the outer conductor terminal 10. In addition to this, the lip portions 22 may be lengthened as the lip portions 23 shown in FIG. 7 and the lip portions 23 may be ultrasonically welded to the terminal part 11.

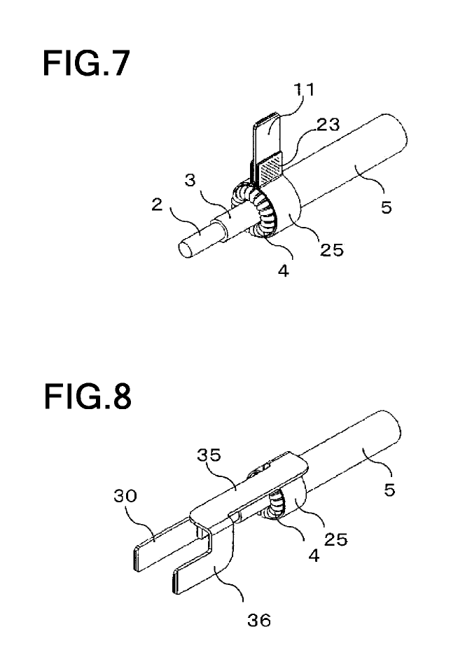

Also, in the second illustrative embodiment, the terminal part 11 of the outer conductor terminal 10 has the flat plate shape. However, the invention is not limited thereto and may be also applied to an outer conductor terminal having a shape where a terminal 35 and a terminal 36 having a flat plate shape, which are formed in conformity to a shape of a mating terminal of a connection target by bending a plate material, are connected, as shown in FIG. 8.

The present application is based on Japanese Patent Application No. 2012-105123, filed on May 2, 2012, the entire contents of which are incorporated herein by reference.

### INDUSTRIAL APPLICABILITY

According to the exemplary embodiment, there is provided a connection structure of an outer conductor terminal to an electric wire, which can reduce a size of a connection part of the outer conductor terminal

### REFERENCE SIGNS LIST

1: electric wire

2: core wire

3: insulating cover

4: outer conductor

5: protective cover

10: outer conductor terminal

12: cylindrical part

20: C-shaped ring

21: opening

22: lip portion

1. An outer conductor terminal for connecting an electric wire to an outer conductor, the electric wire including an internal conductor, an insulating cover covering an outer periphery of the internal conductor, an outer conductor having a twisted wire to wrap an outer periphery of the insulating cover, and a protective cover covering an outer periphery of the outer conductor, the outer conductor terminal comprising:
a terminal part that is formed at one end portion of a flat plate;
a cylindrical part that is formed at the other end portion of the flat plate by bending the other end portion of the flat plate and covers a part of the outer periphery of the insulating cover adjacent to an exposed portion of the outer conductor exposed by stripping the protective cover or a part of an outer periphery of the protective cover adjacent to the exposed portion; and
a C-shaped ring that has an opening portion at a position corresponding to the terminal part and covers the cylindrical part,
wherein the twisted wire of the outer conductor is in contact with an outer periphery of the cylindrical part and an inner periphery of the C-shaped ring, and
the C-shaped ring is crimped to connect the twisted wire of the outer conductor to the outer periphery of the cylindrical part.

2. The outer conductor terminal according to claim 1, wherein the C-shaped ring has a lip portion that is formed by bending a leading edge of the opening toward an outer side in a radial direction of the ring.

3. The outer conductor terminal according to claim 2, wherein the lip portion is ultrasonically welded to the terminal part of the outer conductor terminal.
